(19) United States
(12) Patent Application Publication
(10) Pub. No.: US 2026/0124654 A1
(43) Pub. Date: May 7, 2026

(54) METHOD FOR EMERGENCY REMEDIATING HALOGENATED ORGANIC CONTAMINATED SITE WITH METAL-RICH BIOCHAR

(71) Applicant: SHENZHEN POLYTECHNIC, Shenzhen (CN)

(72) Inventors: Lei WANG, Shenzhen (CN); Shaofeng LI, Shenzhen (CN); Jinhua ZHAN, Shenzhen (CN); Xiaoshu WANG, Shenzhen (CN); Yangyang WANG, Shenzhen (CN); Jiancong LIU, Shenzhen (CN); Jinsheng WANG, Shenzhen (CN); Jin LIU, Shenzhen (CN)

(73) Assignee: SHENZHEN POLYTECHNIC, Shenzhen (CN)

(21) Appl. No.: 18/682,966

(22) PCT Filed: Aug. 12, 2022
(86) PCT No.: PCT/CN2022/112188

§ 371 Date: Feb. 12, 2024

(30) Foreign Application Priority Data
Aug. 13, 2021 (CN) 202110930553.7

(51) Int. Cl. B09C 1/10; B09C 1/08

(52) U.S. Cl. CPC B09C 1/10; B09C 1/085; B09C 2101/00

(57) ABSTRACT

It discloses a method for emergency remediating halogenated organic polluted site(s), by constructing a microelectric field driven bioelectrochemical system of engineering bacteria and auxiliary agent(s). The micro-electric field has cast iron electrode or copper zinc biochar electrode as the anode and plastic electrode as the cathode. The copper zinc biochar is produced by enriching copper, zinc in situ in watercanna, and then pyrolysizing, efficient improving electron transfer capability. By staged replacement of electrodes, showering engineering bacteria and auxiliary agents onto site(s), the sintered iron-rich biochar, which enriches iron in an iris, mediates extracellular electron transport of engineering bacteria and promotes the process of reducing dehalogenation of persistent halogenated organic pollutants. The present invention is particularly pronounced for emergency remediation and treatment of halogenated organic pollutants at halogenated contaminated sites with removal rates of more than 95%.

### TECHNICAL FIELD

The present invention belongs to the technical field of environmental protection and in particular relates to a method of emergency remediating halogenated organic polluted site(s).

### BACKGROUND OF THE INVENTION

Much of the pollution sites in China are within urban areas, there are also a small portion of contaminated sites within ecologically sensitive areas. Since industry is the most major cause of the occurrence of contaminated sites, heavy pollution industry sites are the most dense areas of pollution sites or areas, such as petrochemicals, manufacturing, printing, landfills, filling stations, metal slag stockpiles, waste reclaiming sites and electronic waste disposal sites. Untimely remediation or treatment of pollution sites, it will potentially have a great impact on people's work, life, and will hinder the sustainable development of society, therefore pollution remediation is imminent.

Main reason for formation of organic polluted sites is ability of organic matter polluting soil to enter soil of sites and generate corresponding pollution, and this part of organic pollutants are mainly halogenated organic pollutants.

Haloorganics are often widely used in organic synthesis as starting materials, intermediates, solvents, etc., and are widely used in human production and life. Halogenated organic pollutants mainly include perfluorinated or partially fluorinated compounds (PFCs), chlorinated organics (COCs) and brominated organics (BOCs). Chlorophenol and perfluorooctanesulfonic acid pollutants are widely occurring, representative, recalcitrant organic pollutants, characteristics of strong persistence, remarkable biodegradability, bioaccumulation, high toxicity and ability to migrate over long distances. Once contaminated by the organic pollutants, it is very difficult to treat, and the targeted development of emergency remediation technology appears more urgent.

Remediation techniques for traditionally contaminated sites are not mature and are generally performed by replacement, digging out contaminated soil, replacing it with clean soil, and it is not fundamental remediation.

Currently, an emerging effective soil halo pollution technology is the electrokinetic remediation, which drives the enrichment of contaminants to the electrode region by combined electrochemical and electrokinetic actions (electroosmosis, electromigration and electrophoresis, etc.), so as to being treated or separated. It is suitable for remediating soil contaminated by halogenated organic, such as pentachlorophenol, and has the advantages of faster and lower cost of electric remediation, and is particularly suitable for remediation of a small range of viscous, diverse heavy metal contaminated soils and soluble organic contaminated soils. However, there are also drawbacks, such as requiring chemical solubilization for insoluble organic contaminants and being prone to secondary contamination.

For above reasons, there is great need to seek new methods for efficient and large-scale removal of halogenated organic contaminants.

### SUMMARY OF THE INVENTION

In order to overcome the problems described above, the present inventors have conducted a sharp investigation into methods for removing halogenated organic pollutants from halogenated organic polluted sites, and provide a method for emergency remediating halogenated organic contaminated sites, by constructing a microelectric field driven bioelectrochemical system of engineering bacteria and auxiliary agents. Said micro-electric fields employ cast iron electrodes or copper zinc biochar electrodes as the anode and plastic electrode as the cathode. Said copper zinc biochar of the copper zinc biochar electrode is produced by enriching copper, zinc in situ in watercanna, and then pyrolysizing, and efficient improvement of electron transfer capability. By staged replacement of electrodes, showering engineering bacteria and auxiliaries on site, the sintered iron-rich biochar produced by enriching iron in iris, as an aid mediates extracellular electron transport of engineering bacteria and promotes the process of reducing dehalogenation of persistent halogenated organic pollutants. The present invention is particularly pronounced for emergency treatment of halogenated organic pollutants at halogenated contaminated sites with removal rates of more than 95%.

In particular, it is an object of the present invention to provide the following aspects:

In one aspect, there is provided a method for emergency remediating halogenated organic polluted site, which comprises: constructing bioelectrochemical system of auxiliary agents and engineering bacteria driven by micro-electric field, and degrading halogenated organic pollutants.

In another aspect, there is provided a device for emergency remediating a halogenated organic contaminated site, and said device comprises an electrochemical device and a spray device; said electrochemical device is connected by a power controller between the anode and the cathode; the spray device and a bacterial fluid storage device is connected through a suction pump.

Benefits of the present invention include:
(1) The present invention provides a simple and low cost method for emergency remediating halogenated organic polluted sites, with more than 95% removal of halogenated organic pollutants by constructing bioelectrochemical systems of auxiliaries and engineering bacteria driven by micro-electric field.
(2) In the emergency remediation method provided herein, halogenated organic pollutant degradation rates of typical halogenated organic pollutants such as chlorophenol are 115-371% compared to traditional microbiological methods, with microbial quantities of 10.0-11.0 CFU/g, which being improved by 1-2 order of magnitude.
(3) In the emergency remediation method provided herein, iron is enriched in iris in situ and is sintered to produce iron-rich biochar, which as an auxiliary agent mediating extracellular electron transport of engineering bacteria, to promote the process of reducing dehalogenation of persistent halogenated organic pollutants.
(4) In the emergency remediation method provided herein, the stability of copper and zinc biochar produced by in situ riching copper and zinc is enhanced and electron transfer capability is significantly improved.

### BRIEF DESCRIPTION OF DRAWINGS

FIG. 1 illustrates a schematic view of the device for emergency remediating a halogenated organic pollution site in accordance with a preferred embodiment of the present invention.

### DETAILED DESCRIPTION OF THE INVENTION

The present invention will be described in further detail below by means of the accompanying drawings and examples. The characteristics and advantages of the present invention will become clearer from these descriptions.

The word “exemplary” used herein exclusively means “serving as example, embodiment, or illustration.” Any embodiment described herein as “exemplary” is not necessarily to be construed as preferred or advantageous over other embodiments. Although various aspects of embodiments are shown in drawings, drawings are not necessarily drawn to scale, unless specifically noted.

In recent years, with the rapid development of science and technology, contaminated site remediation treatment technologies are also becoming more mature. Microbial remediation is primarily the use of microbes to degrade halogenated organic matter in soils of contaminated sites, degradation or decomposition of haloorganics is thoroughly achieved by microbes as final electron acceptors of the respiratory chain to eventually decompose into carbon dioxide and water. But microbe remediation technologies are somewhat influenced by pollutant species, soil characteristics and environmental factors.

Electrodynamic remediation techniques have advantages of faster remediation and lower cost, lesser influenced by pollutant species, soil characteristics and environmental factors. As a result, combined remediation techniques with microbes enhanced by electrokinetic actions for haloorganic contaminated soils are developed to overcome the deficiencies of microbiological and electrokinetic remediation techniques, to achieve complete degradation or decomposition of the haloorganic contaminants.

The invention is detailed below.

In one aspect, the invention provides a method for emergency remediating halogenated organic polluted site(s), and the method comprises: constructing a bioelectrochemical system of auxiliary agent (or adjuvant) and engineering bacteria driven by micro-electric field, and degrading halogenated organic pollutants.

Said micro-electric field has cast iron electrode or copper zinc biochar electrode as the anode 5 and plastic electrode as the cathode 6. The power controller 3 provides a voltage of less than 1 V, preferably 0.1 to 0.8 V. Engineering bacteria inoculation and adjuvant spraying are carried out at the halogenated organic pollution site, and iron-rich biochar as the adjuvant mediates extracellular electron transport of the engineering bacteria, enhancing the persistent reductive dehalogenation process of halogenated organic pollutant.

According to the present invention, the copper-zinc biochar electrode is made by compressing copper-zinc biochar onto an electrode substrate.

Further, copper-zinc biochar is biochar enriched in metallic copper and metallic zinc, produced by pyrolyzing emergent plant absorbing both elements by adding copper source and zinc source during cultivation of the emergent plant.

Said emergent plant is preferably emergent plants that enrich well for both copper and zinc, such as watercanna (or powdery thalia).

In the present invention, the broth required for growth of the emergent plant is preferably Hoagland broth to supplement the necessary elements, such as N, P, K, etc. of the plant.

In the present invention, the copper source comprises ionic copper or complexed copper, preferably ionic copper such as copper nitrate, copper chloride, more preferably copper nitrate, and the zinc source is ionic zinc, such as zinc chloride, zinc nitrate, zinc sulfate, preferably zinc nitrate.

In the present invention, ionic copper or ionic zinc transports rapidly in emergent plants, and can be present in complex form in combination with organic acids in the nutrient solution, forming stable chelates, therefore solving precipitation or oxidation of trace elements in the nutrient solution in combination with other ions such as sulfate, low efficiency of absorption, and facilitating absorption, transport and transfer of copper and zinc.

According to the present invention, during cultivation of aquatic plants, the concentration of added copper element and zinc element cannot exceed the tolerance range of the plant. The added copper element is present in the broth at a concentration of 100-600 mg/L, the concentration of zinc element in the broth is 100-600 mg/L, preferably 150-300 mg/L, 200-400 mg/L, more preferably 200-250 mg/L, 260-300 mg/L. The aquatic plant is both stressed to grow and enriched with more copper and zinc elements.

According to the present invention, pyrolysis has effects the mechanicity, the specific surface area and the enrichment or coating of copper and zinc in the produced copper-zinc biochar. The copper and zinc elements in the copper-zinc biochar are reduced by carbon under high temperature conditions to elemental alloy or intermetallic of CuZn metal, which will enhance the electron transferability of the biochar. The pyrolysis comprises:
Low temperature stage: the temperature is 300-500° C., the time is 0.5-5 h, and heating rate is 2-6° C./min;
High temperature stage: the temperature is 550-850° C., the time is 1-4 h, and heating rate is 7-13° C./min.

Preferably, the pyrolysis comprises:
Low temperature stage: the temperature is 350-420° C., the time is 1-4 h, and heating rate is 3-5° C./min;
High temperature stage: the temperature is 600-750° C., the time is 2-3 h, and heating rate is 9-12° C./min.

More preferably, the pyrolysis comprises:
Low temperature stage: the temperature is 370° C., the time is 1.5 h, and heating rate is 4° C./min;
High temperature stage: the temperature is 700° C., the time is 2.5 h, and heating rate is 10° C./min.

According to the present invention, the plastic electrode is preferably selected from Sartorius PY-ASI three-in-one plastic electrode, E-201-9 PH composite electrode or Corida 1.0 plastic electrode CON 1134-13, more preferably Sartorius PY-ASI three-in-one plastic electrode.

In the present invention, the iron-rich biochar is produced by adding an iron source to the hydroponic process of aquatic plants such as irises, which being able to enrich well with ferrous element, collecting obtained biomass at the end of growth, and sintering.

Further, broth used to grow iris is Hoagland nutrient solution.

Said iron source comprises inorganic iron source, organic iron source or chelated iron, preferably chelated iron, such as EDTA-Fe.

In the present invention, EDTA-Fe is chemically stable, easily soluble in water, and EDTA encloses metallic iron ions in a steric hexahedron, and has excellent chelating effect. In particular, iron elements in EDTA-Fe can be more readily absorbed by iris, improving utilization, and producing iron-rich biochar with high content and good enrichment.

In accordance with the present invention, higher Fe chelation values favor uptake and utilization of nutrient elements in the broth by the iris, but uptake capacity of iris for elements and nutrient solution is limited, therefore, the iron element concentration in the broth is 100-700 mg/L, preferably 300-500 mg/L, more preferably 400 mg/L.

In the present invention, upon sintering, iron elements are reduced by carbon to α-Fe and γ-Fe, which have less electrical resistance and also enhance the electron transferability of the biochar.

The temperature of sintering is 500-900° C., the time is 2-8 h, and heating rate is 5-10° C./min; preferably, the temperature of sintering is 700-850° C. the time is 3-5 h, and heating rate is 7-9° C./min; more preferably, the temperature of sintering is 800° C., the time is 4 h, and heating rate is 8° C./min.

In the present invention, the engineering bacteria include anaerobic engineered bacteria and aerobic engineering bacteria. The anaerobic engineering bacteria are preferably selected from any one or several of Dehalococcus, Dehalopseudococcus, Dehalomonas, Flavobacterium, Enterobacter, Pseudomonas aeruginosa, Rhizobium japonicum, Dehalococcoides, more preferably Dehalococcoides or Flavobacterium; and the aerobically engineering bacteria are preferably selected from any one or several of Stenotrophomonas maltophilia, Bacillus cereus, Bacillus lysinus, Microbacterium, more preferably Stenotrophomonas maltophilia.

In accordance with the present invention, in the bioelectrochemical system, halogenated organic pollutants are dehalogenated and oxidized by means of staged dosing of auxiliary agent and engineering bacteria, applying electric field and switching electrodes, resulting in degradation of halogenated organic pollutants.

In particular, the method for emergency remediating halogenated organic pollution sites comprises:

First stage: spraying anaerobic engineering bacteria I and auxiliary agent (or adjuvant) onto sites, and starting electric field reaction.

In first stage, electric field is applied with cast iron electrode as anode 5 and plastic electrode as cathode 6, and voltage supplied by power supply controller 3 is between 0.2 and 0.9 V, preferably between 0.6 and 0.8 V.

Said anaerobic engineering bacteria I is selected from any one or several of Dehalococcus, Dehalopseudococcus, Dehalomonas, Rhizobium japonicum, Dehalococcoides, preferably Dehalococcoides.

Furthermore, anaerobic engineering bacteria I is added in an amount of 1-7 kg per acre, preferably 3-6 kg per acre, more preferably 4-5 kg per acre; the auxiliary agent is added at dose of less than 400 g/m³, preferably between 150 and 300 g/m³, such as 200 g/m³.

According to the present invention, after turning on the electric field, the oxygen evolution process is replaced with a cast iron electrode dissolution reaction, creating a reducing environment conducive to survival of anaerobic engineering bacteria I. Since the survival of anaerobic engineering bacteria I require a reducing environment of at least 200 mV of redox potential, the cast iron electrode dissolves the ferrous ions produced, enabling rapid consumption of dissolved oxygen in solution, helping to achieve this electrolyte condition.

In the present invention, iron-rich biochar, capable of providing the required electron donators for reductive dechlorination of anaerobic engineering bacteria I, in turn as a desorbent for halogenated organic contaminants, the desorption rate can be up to 85% or more, thereby achieving a fast, efficient bioreductive dehalogenation. Nano zero valent iron in the iron-rich biochar polarizes under the action of an electric field, a myriad of nanogalvanic cell effects formed, reconstructing the stereo micro-electric field in the site of halogenated organic contamination, and forming multi-process electrochemical corrosion, that allows iron-rich biochar as an electron carrier to mediate microbial extracellular electron transport, enhancing redox processes of halogenated organic contaminants, typical halogenated organic contaminant degradation rates, such as chlorophenol are increased by 115-371% over traditional microbiological methods, and microbial quantities reach 10.0-11.0 CFU/g, with an increase of 1-2 orders of magnitude.

According to preferred embodiment, after turning on electric field and reacting for 8 to 15 h, preferably 10 to 13 h, anaerobic engineering bacteria II are sprayed again onto site soil surface and the reaction is continued for 1 to 5 h, preferably for 2 to 3 h.

Said anaerobically engineering bacteria II is selected from any one or several of Flavobacterium, Enterobacter, Pseudomonas aeruginosa, preferably Flavobacterium.

Further, anaerobic engineering bacteria II are added in amount of 2-10 kg per acre, preferably 4-7 kg per acre, more preferably 4.5-6 kg per acre.

In the present invention, anaerobic engineering bacteria II are sprayed onto the site soil surface to mask the dominant species of anaerobic engineering bacteria I through competition among microorganisms, allowing the reaction to continue and proceed efficiently.

In first stage, electrode reversal, i.e. reversal of electric field cathode 6 and anode 5 is performed every 30 min during start-up of electric field reaction.

Wherein, passivation of ferroelectric electrode material can be effectively prevented by employing electrode reversal charging.

In first stage, micro-electric fields transport auxiliaries, anaerobic engineering bacterial I and anaerobic engineering bacterial II to soil particles and halogenated organic contaminant interfaces using electrokinetic processes, such as electromigration, electroosmosis, solving engineering challenges where microbes cannot quickly reach soil particles or halogenated organic contaminant interfaces.

Second stage: spraying aerobic engineering bacteria onto sites and staring electric field reaction.

In second stage, in electric field, cast iron electrode used in first stage is replaced with copper zinc biochar electrode, and voltage supplied by power controller 3 is adjusted to 0.1-0.5 V, preferably 0.2-0.4 V.

In the present invention, the aerobic engineering bacteria are used in an amount of 0.5-7 kg per acre, preferably 2-6 kg per acre, more preferably 4-5 kg per acre.

According to the present invention, the aerobically engineering bacterium is preferably Stenotrophomonas maltophila.

Further, Stenotrophomonas maltophila is liquid species having concentration of 10⁹-10¹⁰/mL.

In second stage, reaction time is 10-15 h, preferably 12-13 h, and electrode reversal is performed every 30 minutes during reaction, therefore preventing passivation of copper-zinc biochar electrode material.

In second stage, oxygen is introduced into reaction site, optionally using air compressor such as blowing system.

In accordance with the present invention, the second stage, with an air compressor passing oxygen into the soil, guarantees a sufficient oxygen concentration to accelerate the degradation rate of halogenated organic pollutants, catalyzed by copper-zinc biochar electrodes, under conditions fulfilling the oxygen demand for aerobic engineering bacteria

In first phase and second phase, preferably anaerobic engineering bacteria I and auxiliary agents or anaerobic engineering bacteria III are sprayed to site by spray device 4.

Said spray device 4 and bacterial fluid storage device 1 is connected via suction pump 2. The suction pump 2 delivers, under power, substance from bacterial fluid storage device 1 to spray device 4, effecting spraying.

In the present invention, removal of halogenated organic pollutants is greater than 95% after combined remediation of halogenated organic polluted soils with microbes enhanced by electrokinetic at halogenated organic polluted sites.

In another aspect, the present invention provides a device for emergency remediating halogenated organic contaminated sites, comprising an electrochemical device and a spray device 4.

Said spray device 4 and bacterial fluid storage device 1 is connected via suction pump 2.

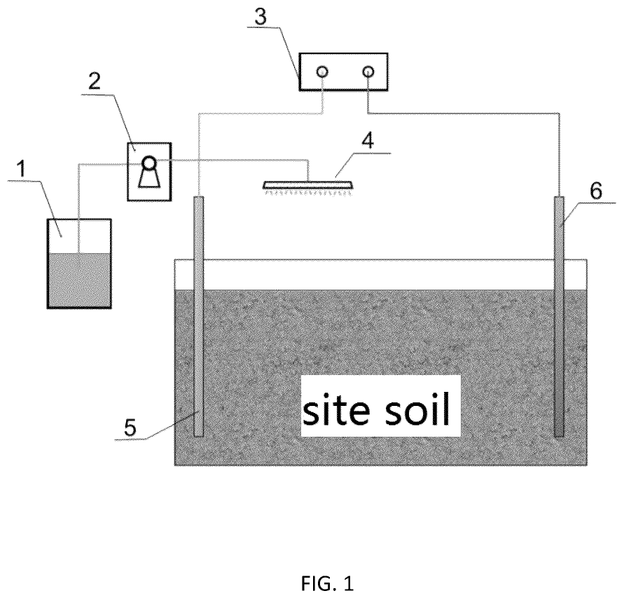

Further, the electrochemical device comprises anode 5, cathode 6 and power controller 3, wherein, anode 5, cathode 6 are inserted into ground of halogenated organic contaminated site, with underground portions of anode 5 and cathode 6 representing 60-96% of length of anode 5 and cathode 6, respectively, and anode 5 and cathode 6 are connected via power controller 3, as shown in FIG. 1.

Optionally, said emergency remediation device for halogenated organic pollution sites further comprises an air compressor.

The invention is further illustrated below with reference to the Examples.

### EXAMPLES

### Example 1

### (1) Preparation of Iron-Rich Biochar

Iris sibiria was planted in an incubator with Hoagland nutrient solution. After one week, EDTA-Fe was dissolved in distilled water, and added to the culture broth. The finally resulting broth had an elemental concentration of iron of 400 mg/L s, and culturing was carried out for 60 days. During the incubation period, the nutrient solution in the incubator was changed over a period of 6 days, keeping the pH of the aqueous solution in the incubator controlled to be in the range of 5.8-6.0. After the end of the experiment, the Iris sibiria was crushed to 9-10 mm to obtain a biomass;

The biomass was fixated at 104° C. for 30 minutes, oven-dried at 80° C. to constant weight, and sintered using a tube muffle furnace in nitrogen atmosphere at heating rate of 8° C./min until sintering temperature of 800° C. and held for 4 h, to yield iron-rich biochar.

### (2) Preparation of Copper Zinc Biochar and Copper Zinc Biochar Electrode

Watercanna was planted in an incubator with Hoagland nutrient solution. After one week, copper nitrate and zinc nitrate were dissolved separately in distilled water, and added to the nutrient solution. The finally resulting nutrient solution had an elemental concentration of copper of 210 mg/L, an elemental concentration of zinc of 260 mg/L, and culturing was carried out for 60 days. During the incubation period, the nutrient solution in the incubator was changed over a period of 7 days, the pH of the aqueous solution in the incubator was kept in the range of 5.9-6.1. After the end of the experiment, the watercanna was fixated at 104° C. for 30 minutes, oven-dried at 80° C. to constant weight, and pyrolyzed using a tube muffle furnace in nitrogen atmosphere as follows to produce copper-zinc biochar:
Low temperature stage: the temperature is 370° C., the time is 1.5 h, heating rate is 4° C./min;
High temperature stage: the temperature is 700° C., the time is 2.5 h, heating rate is 10° C./min.

The copper zinc biochar was charged with Nafion and ethanol in weight ratio of 10:1:4, stirred, and dried to water content of 40%, and then was thermoformed under the pressure of 15 MPa and the temperature of 260° C. to produce copper zinc biochar electrode.

Emergency remediation of halogenated organic contaminated site was carried out at South Mountain District (where located Shenzhen Institute of Occupational Technology) and a site of 5 m×4 m was chosen. The main halogenated organic pollutant at South Mountain District is tetrabromobisphenol A with the concentration of 3 mg/m² as tested by LC-MS.

Dehalococcoides (available from Geosyntec Co.) were scaled up to the concentration of 10¹⁰/mL of bacterial fluid, Flavobacterium (available from Ningbortethto Biotech Co. Ltd.) to the concentration of 10¹¹/mL of bacterial fluid, Stenotrophomonas maltophila (available from Ningbortethto Biotech Co. Ltd.) to the concentration of 10⁸/mL of bacterial fluid.

First stage: the iron rich biochar produced in step (1) was suspended in the Dehalococcoides bacterial fluid, and formed mixture, was placed in the bacterial fluid storage device 1. The suction pump 2 was started, and the mixture was sucked into the spray device 4, and then was sprayed evenly onto the soil surface, so that the anaerobic engineering bacteria Dehalococcoides was dosed 4.2 kg per acre and iron rich biochar was dosed 200 g/m³.

Later, cast iron electrode (available from Longer Ship Electric Co. Ltd.) was used as the anode 5, sartorius PY-ASI three-in-one plastic electrode (available from Sartorius Co.) was used as the cathode 6, and the power controller 3 was turned on, controlling the voltage of 0.7 V. After reaction for 12 h, above Flavobacterium fluid was added into the bacterial fluid storage device 1 and sprayed into the site via spray device 4 to give 4.7 kg per acre dose. The reaction was continued for 2 h, and electrode reversal every 30 min during the reaction.

Second stage: Stenotrophomonas maltophila fluid was added to the bacterial fluid storage device 1, and was sprayed evenly onto the surface of the field soil via spray device 4 to 4.5 kg per acre dose. Then the cast iron electrode was changed to the copper zinc biochar electrode produced in step (2), the voltage was controlled by power controller 3 to 0.3 V and oxygen was purged into the soil using air blowing system for 12 h. Electrode reversal was performed every 30 min during the reaction.

After completion of the reaction, the concentration of tetrabromobisphenol A in soil was determined to decrease to 0.01 mg/m³, and it was seen that tetrabromobisphenol A removal rate reached 99.6%.

Detailed description of the invention by the preferred embodiments and exemplary examples. These specific embodiments are only illustrative explanations of the invention, no limitation is to be placed upon the scope of protection of the invention. Various improvements, substitutions or modifications may be made to the technical disclosure and its embodiments without departing from the spirit and scope of protection of the invention, all falling within the scope of protection of the invention as set forth in the appended claims.

What is claimed is:

1. A method for emergency remediating halogenated organic polluted site, characterized in that, said method comprises: constructing a bioelectrochemical system of auxiliary agent and engineering bacteria driven by a micro-electric field, and degrading halogenated organic pollutants.

2. The method according to claim 1, characterized in that, the micro-electric field has cast iron electrode or copper zinc biochar electrode as the anode (5) and plastic electrode as the cathode (6), and power controller (3) provides a voltage of less than 1 V.

3. The method according to claim 1, characterized in that, said auxiliary agent is iron-rich biochar, and the engineering bacteria include anaerobic engineering bacteria and aerobic engineering bacteria.

4. The method according to claim 1, characterized in that, in the bioelectrochemical system, halogenated organic pollutants are dehalogenated and oxidized by means of staged dosing of auxiliary agent and engineering bacteria, applying electric field and replacing electrodes.

5. The method according to claim 1, characterized in that, the method comprises:
first stage: spraying anaerobic engineering bacteria I and auxiliary agent onto sites, turning on electric field and reacting, said anaerobic engineering bacteria I are selected from any one or several of Dehalococcus, Dehalopseudococcus, Dehalomonas, Rhizobium japonicum, Dehalococcoides;
second stage: spraying aerobic engineering bacteria onto sites, turning on electric field and reacting.

6. The method according to claim 5, characterized in that, in first stage, the electric field is applied with cast iron electrode as anode (5) and plastic electrode as cathode (6), and voltage supplied by power controller (3) is between 0.2 and 0.9 V.

7. The method according to claim 5, characterized in that, said anaerobic engineering bacteria I is added in an amount of 1 to 7 kg per acre, and auxiliary agent is added at dose of less than 400 g/m³.

8. The method according to claim 5, characterized in that, after turning on electric field and reacting for 8-15 h, anaerobic engineering bacteria II are sprayed again onto site soil surface and the reaction is continued for 1-5 h, said anaerobic engineering bacteria II are selected from any one or several of Flavobacterium, Enterobacter, Pseudomonas aeruginosa.

9. The method according to claim 5, characterized in that, in second stage, in the electric field, cast iron electrode used in first phase is replaced with copper zinc biochar electrode, and the voltage applied by power controller (3) is adjusted to 0.1-0.5 V.

10. A device for emergency remediating halogenated organic pollution site, characterized in that, said device comprises an electrochemical device and a spray device (4);
the electrochemical device is connected by power controller (3) between anode (5) and cathode (6);
the spray device (4) and bacterial fluid storage device (1) is connected through suction pump (2).
